(19) United States
(12) Patent Application Publication
(10) Pub. No.: US 2010/0019968 A1
(43) Pub. Date: Jan. 28, 2010

(54) GPS CLOCKING DEVICE AND TIME DETECTION METHOD

(75) Inventor: Ryuji Shingyoji, Ome-shi (JP)

Correspondence Address: TUROCY & WATSON, LLP, 127 Public Square, 57th Floor, Key Tower, CLEVELAND, OH, 44114, US

(73) Assignee: CASIO COMPUTER CO., LTD., Tokyo (JP)

(21) Appl. No.: 12/507,155

(22) Filed: Jul. 22, 2009

(30) Foreign Application Priority Data
Jul. 25, 2008 (JP) 2008-191543

(51) Int. Cl. G01S 1/00

(52) U.S. Cl. 342/357.09

(57) ABSTRACT

According to one embodiment, a GPS clocking device comprises a computing module, a storage module, a reading module, and a correction module. The computing module receives a GPS signal transmitted from a GPS satellite, and computes a receiving position of the GPS signal in the standard coordinate system of the GPS based on the GPS signal. The storage module stores position information which indicates areas different from each other in the employed standard time, and is represented by the standard coordinate system, and information on the time difference between the standard time of each area and standard time of the GPS. The reading module reads time-difference information corresponding to an area to which the receiving position computed by the computing module corresponds from the storage module. The correction module corrects the current time indicated by the time information included in the GPS signal by using the time-difference information.

### CROSS-REFERENCE TO RELATED APPLICATIONS

This application is based upon and claims the benefit of priority from prior Japanese Patent Application No. 2008-191543, filed Jul. 25, 2008, the entire contents of which are incorporated herein by reference.

### BACKGROUND OF THE INVENTION

1. Field of the Invention

The present invention relates to a GPS clocking device having a function of receiving a GPS signal transmitted from a GPS satellite, and detecting the current time by using time information included in the received GPS signal, and a time detection method.

2. Description of the Related Art

Heretofore, in a GPS receiver for measuring the current position by utilizing the Global Positioning System (GPS), GPS signals transmitted from a plurality of (usually four or more) GPS satellites are received, and the current position (receiving position) is calculated based on a navigation message transmitted from each of the satellites. Information on the current position is calculated by temporarily computing position information represented by X, Y, and Z of the Earth Centered, Earth Fixed (ECEF) orthogonal coordinate system which is the standard coordinate system of the GPS based on a position of each of the satellites, and time necessary for a code for position measurement to reach the receiver, and thereafter converting the position information into position information represented by a latitude (φ), longitude (λ), and ellipsoidal height (h) in the geodetic coordinate system of the measurement area.

On the other hand, the navigation message includes time information generated by a clock with high accuracy in each of the satellites, i.e., Time Of Week (TOW) which is a numerical value expressed in units of 6 seconds starting from 00:00:00 of every Sunday. Hence it is possible to correct the current time of an arbitrary clocking device to the exact time by using such time information. Such a method of time correction is known, and is described in, for example, Jpn. Pat. Appln. KOKAI Publication No. 2007-263598.

Incidentally, as the time standard of the GPS (GPS time), Coordinated Universal Time (UTC) is used. Accordingly, in order to obtain the current time from the time information included in the GPS signal, time-difference correction for normalizing the time in accordance with a time difference between the standard time employed in an area (country or the like) at the current position (place at which the user is present) and the UTC is needed. In order to obtain a time difference between the standard time at the current position and the UTC, it is sufficient if time-difference information corresponding to an arbitrary area or a representative city of the area is stored in advance in the clocking device, the user is made to set the area or city in which the clocking device is used, and time-difference information corresponding to the set area is read. Furthermore, in order to carry out the above-mentioned time-difference correction without troubling the user, it is sufficient if the current position (receiving position) is obtained by a position measurement operation based on the GPS signal, the area in which the clocking device is used is identified from the current position, and time-difference information corresponding thereto is obtained.

However, when the time difference corresponding to the current area in which the clocking device is used is obtained as described above, in the position measurement in the GPS, as described previously, the position information (X, Y, Z) based on the ECEF representing the current position is temporarily computed. Then the position information is converted into position information (latitude, longitude, and ellipsoidal height) in the geodetic coordinate system, whereby the time difference is obtained as the final position information. That is, position computation processing of two stages is carried out, and hence there has been a problem that the processing efficiency at the time of obtaining the time-difference information is poor, the electric power consumption is large, and much time is required.

### BRIEF SUMMARY OF THE INVENTION

An object of the present invention is to provide a GPS clocking device and a time detection method capable of reducing the electric power consumption and required time when time-difference information which is required for detecting the current time from time information included in a GPS signal is obtained.

A GPS clocking device according to one embodiment of the invention comprises a computing module configured to receive a GPS signal transmitted from a GPS satellite, and to compute a receiving position of the GPS signal in the standard coordinate system of the GPS based on the received GPS signal; a storage module configured to store position information which indicates areas different from each other in the employed standard time, and is represented by the standard coordinate system, and information on the time difference between the standard time of each area and standard time of the GPS; a reading module configured to read time-difference information corresponding to an area to which the receiving position computed by the computing module corresponds from the storage module; and a correction module configured to correct the current time indicated by the time information included in the GPS signal by using the time-difference information read by the reading module.

A time detection method according to another embodiment of the invention comprising: receiving a GPS signal transmitted from a GPS satellite; computing a receiving position of the GPS signal in the standard coordinate system of the GPS based on the received GPS signal; storing position information which indicates areas different from each other in the employed standard time, and is represented by the standard coordinate system, and information on the time difference between the standard time of each area and standard time of the GPS; reading time-difference information corresponding to an area to which the receiving position computed by the computing module corresponds from the storage module; and correcting the current time indicated by the time information included in the GPS signal by using the time-difference information read by the reading module.

### BRIEF DESCRIPTION OF THE SEVERAL VIEWS OF THE DRAWING

FIG. 1 is a block diagram showing a GPS clocking device according to an embodiment of the present invention.

FIG. 2 is a block diagram showing the specific configuration of a GPS receiving module according to the embodiment.

FIG. 3 is a conceptual view showing data stored in an urban information storage module according to the embodiment.

FIG. 4 is a flowchart showing the current time detection according to the embodiment.

### DETAILED DESCRIPTION OF THE INVENTION

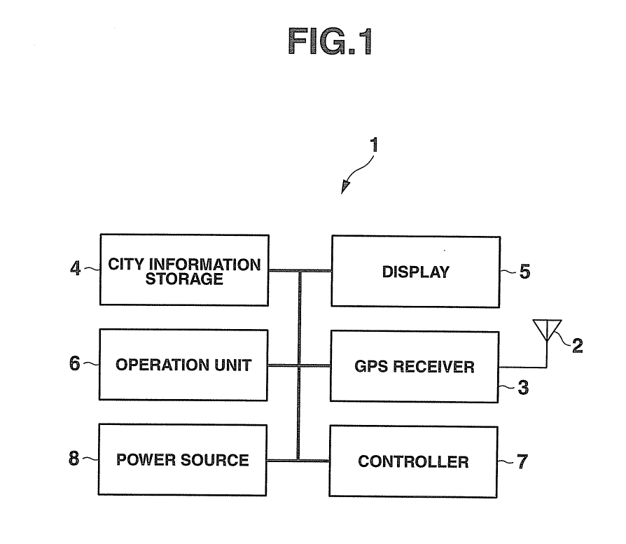

An embodiment of the present invention will be described below in accordance with the accompanying drawings. FIG. 1 is a block diagram showing a GPS clocking device 1 of an embodiment of the present invention having a function of detecting the current time by using time information included in a GPS signal transmitted from a GPS satellite. The GPS clocking device 1 includes an antenna 2 for receiving a radio signal from the GPS satellite, GPS receiver 3, city information storage 4, display 5, operation unit 6, controller 7, and power source 8.

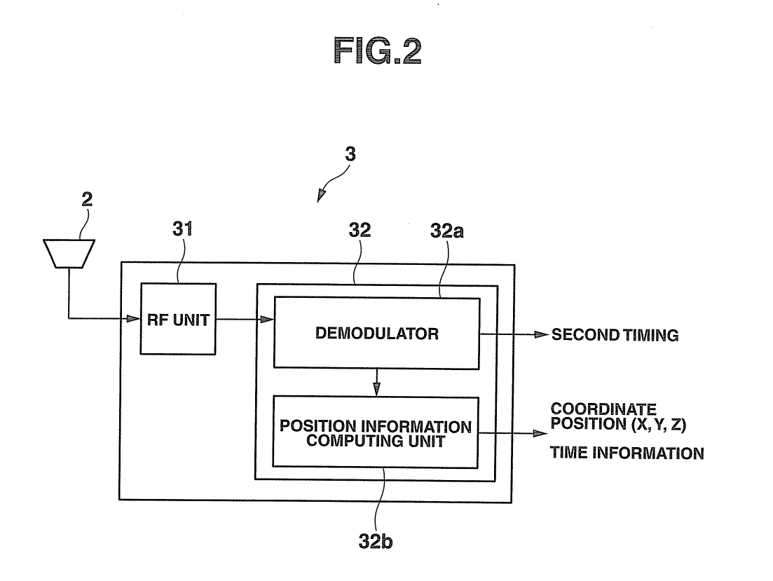

As shown in FIG. 2, the GPS receiver 3 includes, as main constituent elements, an RF unit 31 for amplifying a radio signal input from the antenna 2, i.e., a GPS signal, and converting the signal into a digital intermediate-frequency signal, and a signal processing unit 32 for processing GPS signals of satellites output from the RF module 31.

The signal processing unit 32 includes, as main constituent elements, a demodulator 32a and computing unit 32b. The demodulator 32a demodulates a navigation message included in the GPS signal, outputs the demodulated navigation message to the computing unit 32b, detects second timing for time correction based on the GPS signal, and outputs the second timing to the controller 7.

The computing unit 32b computes the current position (receiving position) based on the position of each satellite, and time necessary for a code for position measurement to reach the receiver by using the time information (TOW: Time Of Week), ephemeris, satellite clock information, ionospheric correction data, almanacs, and the like which are included in the navigation message supplied from the demodulating module 32a. At this time, unlike in the conventional GPS receiver, only position information represented by the coordinate values (X, Y, Z) of the ECEF orthogonal coordinate system which is the standard coordinate system of the GPS is computed as the current position. The information is output to the controller 7. Further, the computing module 32b detects the exact time indicated by the time information of the satellite clock, and outputs the detected time to the control module 7.

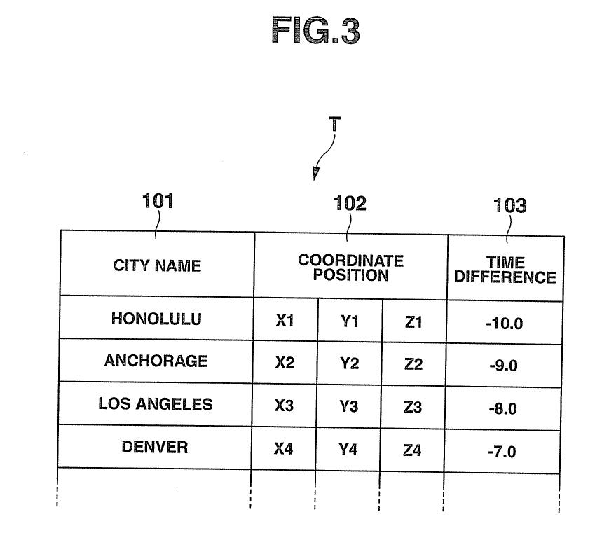

The city information storage module 4 stores therein a time-difference lookup table T shown in FIG. 3. In the time-difference lookup table T, names of cities 101 of major cities (capitals or the like) of all the countries of the world, coordinate positions (X, Y, Z) 102 of the city names, and data of time differences 103 are stored to be associated with each other. In the names of the cities of such a country as the United States in which a plurality of systems of standard time are used, names of cities of each area in which each of the systems of standard time is used are included.

The coordinate position (X, Y, Z) 102 is position information representing a position (central position or the like) of a major city by the ECEF orthogonal coordinate system, i.e., position data indicating the position of the major city. The coordinate position (X, Y, Z) 102 is generated by converting in advance data of the latitude, longitude, and altitude conforming to a geodetic reference system employed in the country or area into data of the ECEF orthogonal coordinate system. The time difference 103 is a difference in time between the standard time employed in the country or area represented by the name of the city 101 and the Coordinated Universal Time (UTC).

The operation unit 6 includes operation switches used by the user to operate the GPS clocking device 1. Operation states of the individual switches are successively detected by the control module 7. The power source module 8 includes various primary or secondary batteries, a DC-DC converter, and the like, and supplies necessary power to the GPS receiver 3, display 5, and controller 7.

The controller 7 controls the overall device, and is provided with a clock function of keeping the current time. Though not shown, the controller 7 includes a CPU, a ROM in which a predetermined control program is stored, a RAM as a working memory, an oscillator for generating a clock signal, a frequency divider for dividing a clock signal to generate a second pulse, and a clock circuit including a time counter. The current time detected by the controller 7 is displayed on the display 5. Note that among the names of the cities recorded on the city information storage 4, the name of the city corresponding to the area of the place at which the device is used is also displayed on the display 5.

Further, GPS clocking device 1 of this embodiment, for example, when a predetermined operation button is pressed by the user at an arbitrary point in time prior to the first use after replacement of the battery, or when an instruction to reset the device is issued by the user by pressing the predetermined operation button after the start of use, sets the current time by the following operations.

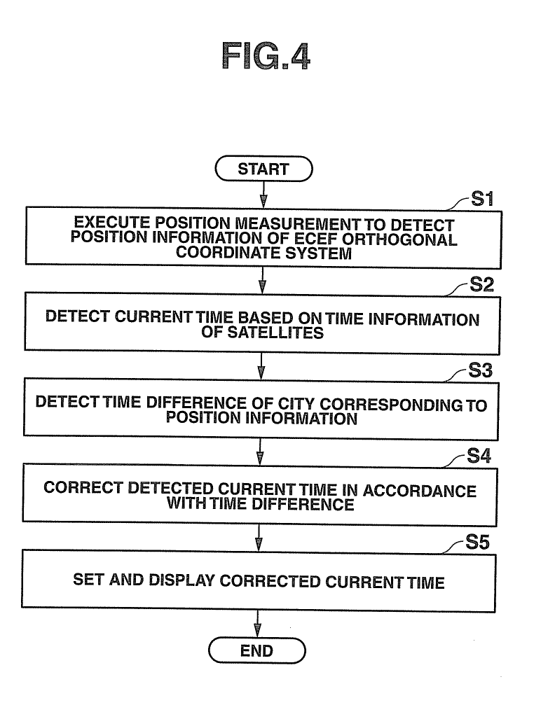

FIG. 4 is a flowchart showing the operation descriptions of the GPS clocking device 1. In the GPS clocking device 1, the GPS receiver 3 measures the current position based on GPS signals received from a plurality of GPS satellites, detects the above-mentioned position information (X, Y, Z) of the ECEF orthogonal coordinate system (step S1), and detects the current time based on the time information of the satellites (step S2).

The controller 7 reads data items of the name of the city 101 and time difference 103 corresponding to the position information (X, Y, Z) detected by the GPS receiver 3 from the above-mentioned time-difference lookup table T (FIG. 3), i.e., the controller 7 reads the data items from the city information storage 4 (step S3). Then, the controller 7 corrects the current time detected by the GPS receiver 3 in accordance with the above-mentioned time difference, i.e., the time difference between the current time at the current position (place at which the user is present) and the UTC (step S4). Thereafter, the corrected current time is set as the final current time, and is displayed on the display 5 (step S5). Note that the name of the city 101 is also displayed on the display 5 at that time.

Further, in the GPS clocking device 1, although not shown, after the current time is set as described above, the controller 7 causes the GPS receiver 3 to receive the GPS signal at predetermined time intervals, and corrects the second timing of the current time displayed on the display 5 based on the second timing for time correction detected by the GPS receiver 3. Further, at this time (different time intervals may be employed), the controller 7 detects the exact current time corresponding to the place at which the user is present by the same operation as that to be performed, for example, when the instruction to reset the device is issued (shown in FIG. 4).

As described above, in the GPS clocking device 1 of this embodiment, although the time-difference information which is required for detecting the current time based on the time information included in the GPS signal is obtained, at this time, the position information (X, Y, Z) of the ECEF orthogonal coordinate system is detected as the current position, and the time-difference information described above is directly obtained from the time-difference lookup table T (FIG. 3) by using such position information as it is. That is, the time-difference information described above is obtained without converting the position information of the ECEF orthogonal coordinate system into the position information (latitude, longitude, and ellipsoidal height) in the geodetic coordinate system which is position information originally unnecessary for detecting the current time.

Accordingly, there is no uselessness in the processing to be carried out when the time-difference information is obtained, and it is possible to reduce the electric power consumption and required time when the time-difference information is automatically obtained. Furthermore, it is possible to simplify the circuit configuration of the above-mentioned GPS receiver 3, more specifically computing unit 32b, and hence it is also possible to reduce the cost of the GPS clocking device 1.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means. Though the position information in which the position (central position or the like) of the major city is represented by the ECEF orthogonal coordinate system as the coordinate position (X, Y, Z) 102 is stored in the city information storage 4, such position information is not limited to the positions of the major cities.

Landmarks (sightseeing attraction spots such as famous mountains, lakes, and the like, sightseeing facilities, buildings, and the like) may be stored if only they are represented by the ECEF orthogonal coordinate system.

What is claimed is:

1. A GPS clocking device comprising:
a computing unit configured to receive a GPS signal transmitted from a GPS satellite and to compute a receiving position of the GPS signal in a standard coordinate system of a GPS based on the received GPS signal;
a storage configured to store position information which indicates areas of different standard times and is represented by the standard coordinate system and to store time difference information between the standard time of each area and a standard time of a GPS;
a reading unit configured to read, from the storage, time difference information corresponding to an area in which the receiving position computed by the computing unit is located; and
a correction unit configured to correct a current time indicated by time information included in the GPS signal by using the time difference information read by the reading unit.

2. The GPS clocking device according to claim 1, wherein
the computing unit is configured to compute the receiving position represented by the coordinate values (X, Y, Z) of the ECEF orthogonal coordinate system which is the standard coordinate system of the GPS based on a position of each satellite, and time necessary for a code for position measurement to reach the GPS clocking device by using Time Of Week information, ephemeris, satellite clock information, ionospheric correction data, and almanacs which are included in the GPS signal transmitted from a certain GPS satellite.

3. The GPS clocking device according to claim 1, wherein the standard time of the GPS comprises Coordinated Universal Time.

4. A time detection method comprising:
receiving a GPS signal transmitted from a GPS satellite;
computing a receiving position of the GPS signal in a standard coordinate system of a GPS based on the received GPS signal;
reading, from a storage configured to store position information which indicates areas of different standard times and is represented by the standard coordinate system, and to store time difference information between the standard time of each area and a standard time of the GPS, time difference information corresponding to an area in which the computed receiving position is located; and
correcting a current time indicated by time information included in the GPS signal by using the read time difference information.

5. The time detection method according to claim 4, wherein
the computing comprises computing the receiving position represented by the coordinate values (X, Y, Z) of the ECEF orthogonal coordinate system which is the standard coordinate system of the GPS based on a position of each satellite, and time necessary for a code for position measurement to reach the GPS clocking device by using Time Of Week information, ephemeris, satellite clock information, ionospheric correction data, and almanacs which are included in the GPS signal transmitted from a certain GPS satellite.

6. The time detection method according to claim 4, wherein the standard time of the GPS comprises Coordinated Universal Time.
